(19) United States
(12) Patent Application Publication
(10) Pub. No.: US 2024/0205834 A1
(43) Pub. Date: Jun. 20, 2024

(54) PHYSICAL UPLINK CONTROL CHANNEL RELIABILITY ENHANCEMENT

(71) Applicant: Apple Inc., Cupertino, CA (US)

(72) Inventors: Haitong SUN, Cupertino, CA (US); Chunxuan YE, San Diego, CA (US); Dawei ZHANG, Saratoga, CA (US); Hong HE, San Jose, CA (US); Sigen YE, San Diego, CA (US); Wei ZENG, Saratoga, CA (US); Weidong YANG, San Diego, CA (US); Yushu ZHANG, Beijing (CN)

(21) Appl. No.: 17/906,113

(22) PCT Filed: Sep. 24, 2021
(86) PCT No.: PCT/CN2021/120209

§ 371 Date: Sep. 12, 2022

(51) Int. Cl. H04W 52/08; H04W 52/14; H04W 52/38

(52) U.S. Cl. CPC H04W 52/08; H04W 52/146; H04W 52/38

(57) ABSTRACT

Embodiments of the present disclosure relate to Physical Uplink Control Channel (PUCCH) reliability enhancement. According to embodiments of the present disclosure, a processor of a UE receives, from a BS associated with a first TRP and a second TRP, a first message for configuring a PUCCH resource to be used by the UE to perform a PUCCH transmission with the BS. In this case, the first message indicates a first configuration corresponding to the first TRP and the first configuration comprises at least one power control parameter associated with the first TRP. The message further indicates a second configuration corresponding to the second TRP and the second configuration comprises at least one power control parameter associated with the second TRP. The processor performs the PUCCH transmission with the BS via the first and second TRPs based on the first message. In this way, the reliability and robustness of the PUCCH transmission for multiple TRP is enhanced.

### TECHNICAL FIELD

Embodiments of the present disclosure generally relate to the field of telecommunications, and in particular, to Physical Uplink Control Channel (PUCCH) reliability enhancement.

### BACKGROUND

In order to improve the reliability and robustness of the communication between the BS, and a User Equipment (UE), technology of multi-Transmission and Reception Point (multi-TRP, as well as multi-panel reception) has been proposed and discussed recently. PUCCH resources and PUCCH beams used for a particular PUCCH transmission can be configured with higher-layer signallings such as Radio Resource Control (RRC) and Media Access Control Control Element (MAC CE).

### SUMMARY

In general, example embodiments of the present disclosure provide a solution for PUCCH transmission using multiple TRPs reliability enhancement.

In a first aspect, there is provided a processor of a user equipment (UE). The processor of the UE is configured to perform operations comprising receiving, from a BS associated with a first transmission and reception point (TRP) and a second TRP, a first message for configuring a Physical Uplink Control Channel (PUCCH) resource to be used by the UE to perform a PUCCH transmission with the BS. The first message indicates a first configuration corresponding to the first TRP comprising at least one power control parameter associated with the first TRP and a second configuration corresponding to the second TRP comprising at least one power control parameter associated with the second TRP. The operations further comprise performing, based on the first message, the PUCCH transmission with the BS via the first and second TRPs.

In a second aspect, there is provided a processor of a user equipment (UE). The processor of the UE is configured to perform operations comprising: receiving, from a BS associated with a first transmission and reception point (TRP) and a second TRP, a second message comprising at least one transmission power control (TPC) field for adjusting transmission power for the first and second TRPs when the UE performing a PUCCH transmission with the BS via the first and second TRPs; and adjusting, based on the second message, the transmission power of Closed Loop Power Control (CLPC) for the first and second TRPs.

In a third aspect, there is provided a processor of a user equipment (UE). The processor of the UE is configured to perform operations comprising: determine, a repetition number and a pre-configured resource for a Physical Uplink Control Channel (PUCCH) repetition transmission between the UE and a BS via at least one transmission and reception point, the pre-configured resource comprising at least one transmission occasion; during the PUCCH repetition transmission, if a PUCCH transmission on current transmission occasion needs to be dropped, disabling the PUCCH transmission on current transmission occasion and decreasing the repetition number, or skipping the PUCCH transmission on current transmission occasion without decreasing the repetition number.

In a fourth aspect, there is provided a UE. The user equipment comprises a transceiver and a processor according to any of the above first, second and third aspects. The transceiver is configured to communicate with a network.

In a fifth aspect, there is provided a processor of a base station (BS). The processor of the BS configured to perform operations comprising: generating a first message for configuring a Physical Uplink Control Channel (PUCCH) resource to be used by the UE to perform a PUCCH transmission with the BS associated with a first transmission and reception point (TRP) and a second TRP, the first message indicating: a first configuration corresponding to the first TRP, the first configuration comprising at least one power control parameter associated with the first TRP, and a second configuration corresponding to the second TRP, the second configuration comprising at least one power control parameter associated with the second TRP; and transmitting the first message to the UE.

In a sixth aspect, there is provided a processor of a base station (BS). The processor of the BS configured to perform operations comprising: generating a second message comprising at least one transmission power control (TPC) field for adjusting transmission power for a first and second transmission and reception points (TRPs) associated with the BS when the UE performing a PUCCH transmission with the BS via the first and second TRPs; and transmitting the second message to the UE.

In a seventh aspect, there is provided a base station (BS). The BS comprises a transceiver and a processor according to any of the above fifth and sixth aspects. The transceiver is communicatively coupled to the processor and configured to communicate with a user equipment (UE).

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network in which example embodiments of the present disclosure can be implemented;

FIG. 2 illustrates a signaling flow for configuring a PUCCH resource for a multiple TRP transmission according to some embodiments of the present disclosure;

FIG. 3 illustrates a signaling flow for adjusting the transmission power for CLPC for a multiple TRP transmission according to some embodiments of the present disclosure;

FIG. 4 illustrates a flowchart illustrating an example method of determining PUCCH repetition pattern for a multiple TRP transmission performed by the UE according to some embodiments of the present disclosure;

FIG. 5 illustrates a flowchart illustrating an example method of determining PUCCH repetition pattern for a multiple TRP transmission performed by the UE according to some other embodiments of the present disclosure;

FIG. 6 illustrates a schematic block diagram of a PUCCH repetition pattern corresponding to according to some embodiments illustrated in FIG. 4;

FIG. 7 illustrates a schematic block diagram of a PUCCH repetition pattern corresponding to according to some embodiments illustrated in FIG. 5;

FIG. 8 illustrates a flowchart illustrating an example method of configuring a PUCCH resource for a multiple TRP transmission performed by the UE according to some embodiments of the present disclosure;

FIG. 9 illustrates a flowchart illustrating an example method of adjusting the transmission power for CLPC for a multiple TRP transmission performed by the UE according to some embodiments of the present disclosure;

FIG. 10 illustrates a flowchart illustrating an example method of configuring a PUCCH resource for a multiple TRP transmission performed by the BS according to some embodiments of the present disclosure;

FIG. 11 illustrates a flowchart illustrating an example method of adjusting the transmission power for CLPC for a multiple TRP transmission performed by the BS according to some embodiments of the present disclosure; and

FIG. 12 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. For example, as used herein, the singular forms “a”, “an” and “the” are intended to include the plural forms as well, unless the context clearly indicates otherwise. The terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. Moreover, when a particular feature, structure, or characteristic is described in connection with some embodiments, it is submitted that it is within the knowledge of one skilled in the art to affect such feature, structure, or characteristic in connection with other embodiments whether or not explicitly described.

It is also to be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT), New Radio (NR) and so on. Furthermore, the communications between a UE and a BS in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “Base station” or “BS” refers to a node in a communication network via which a user equipment accesses the network and receives services therefrom. The BS may refer to for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “user equipment” refers to any end device that may be capable of wireless communication. By way of example rather than limitation, a UE may also be referred to as a communication device, a Subscriber Station (SS), a Portable Subscriber Station, a Mobile Station (MS), or an Access Terminal (AT). The UE may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

As used herein, the term “TRP” refers to an antenna array (with one or more antenna elements) available to the BS located at a specific geographical location. Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As discussed above, in order to improve the reliability and robustness of the communication between the BS and the terminal device, technology of multi-TRP (as well as multi-panel reception) has been proposed and discussed recently. Specifically, some agreements about enhancement on the support for multi-TRP deployment have been reached, comprising:
Identify and specify features to improve reliability and robustness for physical channels (such as, PDCCH, PUSCH and/or PUCCH other than PDSCH) using multi-TRP and/or multi-panel with Release 16 reliability features as a baseline;
Identify and specify features to enable inter-cell multi-TRP operations; and
Evaluate and, if needed, specify enhancements for simultaneous multi-TRP transmission with multi-panel reception.

Further, it is agreed to enhance the PUCCH/PUSCH reliability for multi-TRP operations.

In conventional solutions, for one PUCCH resource, only one beam can be configured. Therefore, it would be desirable to propose a solution for configuring the PUCCH resource for multiple beams i.e., for a multi-TRP transmission.

Embodiments of the present disclosure propose a solution for configuring the PUCCH resource associated with multi-TRP transmission. In this solution, a processor of a UE receives, from a BS associated with a first TRP and a second TRP, a first message for configuring a PUCCH resource to be used by the UE to perform a PUCCH transmission with the BS. In this case, the first message indicates a first configuration corresponding to the first TRP and the first configuration comprises at least one power control parameter associated with the first TRP. The first message further indicates a second configuration corresponding to the second TRP and the second configuration comprises at least one power control parameter associated with the second TRP. The processor of the UE performs the PUCCH transmission with the BS via the first and second TRPs based on the first message.

According to embodiments of the present disclosure, the processor of the UE using a received message indicating configuration information corresponding to a first and a second TRPs to configure the PUCCH resource corresponding to both of the TRPs, respectively. In this way, PUCCH resources associated with a transmission via the first TRP and a transmission via the second TRP can be configured separately according to different desired control scheme. Therefore, the reliability and robustness of the PUCCH transmission for multiple TRP is enhanced.

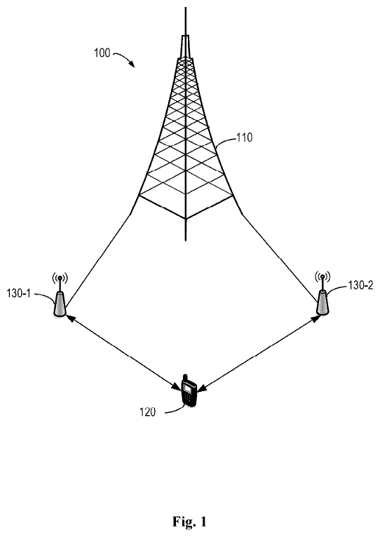

FIG. 1 illustrates an example communication network 100 in which embodiments of the present disclosure can be implemented.

As illustrated in FIG. 1, the communication network 100 includes a BS 110 and a UE 120 served by the BS 110. The UE 120 can communicate with the BS 110 via one or more physical communication channels or links.

In the communication network 100, a link from the UE 120 to the BS 110 is referred to as an uplink (UL), while a link from the BS 110 to the UE 120 is referred to as a downlink (DL). In UL, the UE 120 is a TX device (or a transmitter) and the BS 110 is a RX device (or a receiver). In DL, the BS 110 is a transmitting (TX) device (or a transmitter) and the UE 120 is a receiving (RX) device (or a receiver).

In the specific example of FIG. 1, the BS 110 may configure a UL transmission (such as, a PUCCH transmission) with a Radio Resource Control (RRC) message/signaling or a Medium Access Control (MAC) control element (CE) message/signaling or Downlink Control Information (DCI). Further, the BS 110 may transmit a DCI comprising a TPC field to configure the transmission power.

The communications in the communication network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In addition, in order to support multi-TRP and/or multi-panel, the BS 110 may be equipped with one or more TRPs. For example, the BS 110 may be coupled with multiple TRPs in different geographical locations to achieve better coverage. One or more TRPs of the multiple TRPs may be included in a same serving cell or different serving cells. It is to be understood that the TRP can also be a panel, and the panel can also refer to an antenna array (with one or more antenna elements). As shown in FIG. 1, the BS 110 may communicate with the UE 120 via TRPs 130-1 and 130-2. In the following text, the TRP 130-1 may be also referred to as the first TRP, while the TRP 130-2 may be also referred to as the second TRP. The first and second TRPs 130-1 and 130-2 may be included in a same serving cell or different serving cells provided by the BS 110.

It is to be understood that the numbers of BSs, terminal devices and/or TRPs are only for the purpose of illustration without suggesting any limitations to the present disclosure. The communication network 100 may include any suitable number of BSs, UEs and/or TRPs adapted for implementing implementations of the present disclosure.

In the following text, although some embodiments of the present disclosure are described with reference to two TRPs, namely the first and second TRPs 130-1 and 130-2 within a same serving cell provided by the BS 110, these embodiments are only for the purpose of illustration and help those skilled in the art to understand and implement the present disclosure, without suggesting any limitations as to the scope of the present disclosure. For example, there may be M TRPs serving the UE 120, where M is a positive integer.

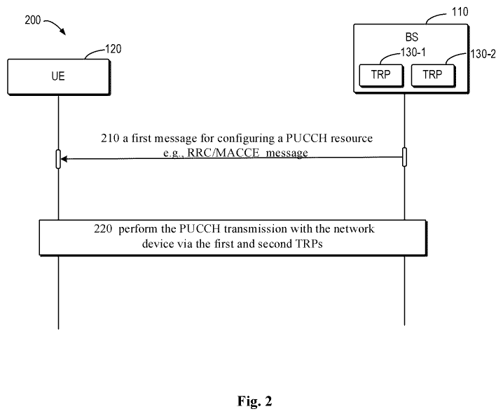

Principle and implementations of the present disclosure will be described in detail below with reference to FIGS. 2-6.

FIG. 2 illustrates a signaling flow for configuring a PUCCH resource according to some embodiments of the present disclosure. For the purpose of discussion, the signaling flow 200 will be described with reference to FIG. 1. The signaling flow 200 may involve the BS 110, the UE 120, the first TRP 130-1 and the second TRP 130-2.

In the specific example of FIG. 2, in the signaling flow 200, the BS 110 transmits 210 a first message (such as, a RRC or MAC CE message) for configuring a PUCCH resource to be used by the UE to perform a PUCCH transmission with the BS via the first TRP 130-1 and the second TRP 130-2 to the UE 110. The first message indicates a first configuration corresponding to the first TRP 130-1. The first configuration comprises at least one power control parameter associated with the first TRP 130-1. The first message further comprises a second configuration corresponding to the second TRP 130-2. The second configuration comprises at least one power control parameter associated with the second TRP 130-2.

The first message may be transmitted via various types of messages. One example of the first message is a RRC message/signaling. Another example of the first message is a MAC CE message/signaling.

Further, the configurations (i.e., the first and second configurations) in the first message may be transmitted via various manners. In some example embodiments, the first message may comprise at least one Information Element (IE) and, the first and the second configurations may be comprised in the at least one IE. In some example embodiments the first configuration and the second configuration are comprised in a first IE and a second IE corresponding to the first TRP 130-1 and the second TRP 130-2, respectively. Alternatively, in some example embodiments, the first configuration and the second configuration may be comprised in a single IE. In particular, in some example embodiments, in case of Frequency Range 2 (FR2, from 24250 MHz to 52600 MHz), the IE may be PUCCH spatial relation information (PUCCH-SpatialRelationInfo). One specific example of part of PUCCH-SpatialRelationInfo is illustrated as below.

| | |
|---|---|
| PUCCH-SpatialRelationInfo ::= | SEQUENCE { |
| pucch-SpatialRelationInfoId | PUCCH-SpatialRelationInfoId, |
| referenceSignal | CHOICE { |
| ssb-Index | SSB-Index, |
| csi-RS-Index | NZP-CSI-RS-ResourceId, |
| srs | SRS-ResourceId |

},

| | |
|---|---|
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |

| | |
|---|---|
| } | . |

For example, in case that the first message is comprised in a MAC CE message, the first message may comprise two PUCCH-SpatialRelationInfo corresponding to the first TRP 130-1 and the second TRP 130-2, respectively. Additionally, an indication indicating a presence of the second PUCCH-SpatialRelationInfo may be comprised in the first message. In this way, by providing two PUCCH-SpatialRelationInfo, the configuration of PUCCH resource for multiple TRP transmission can be achieved by one MAC CE message, which conventionally comprises only one PUCCH-SpatialRelationInfo which is insufficient for multiple TRP transmission.

Alternatively, in case that the IE is not supported, for example transmission in Frequency Range 1 (FR1, from 410 MHz to 7125 MHz), the first and second configurations may be comprised in the first message to transmit the first message without supporting an IE of PUCCH-SpatialRelationInfo.

In particular, in case of Frequency Range 1, PUCCH-SpatialRelationInfo is not supported due to the configuration information of servingCellId and referenceSignal. In these example embodiments, servingCellId and referenceSignal will be removed or ignored by the UE 120.

In some example embodiments, the first configuration may comprise various parameters. For example, the first configuration may comprise at least one first CLPC parameter. The at least one first CLPC parameter is to configure a CLPC process corresponding to the first TRP 130-1. One example of CLPC parameter is an index indicating a corresponding CLPC process maintained at the UE 120. In this way, a CLPC process may be assigned to the PUCCH resource associated with the first TRP 130-1. As one example, the first configuration is comprised in the PUCCH-SpatialRelationInfo, and the CLPC parameter is the closedLoopIndex.

Alternatively, or in addition, the first configuration may further comprise at least one first OLPC parameter. The at least one first OLPC parameter is used to configure an OLPC process corresponding to the first TRP 130-1. One example of OLPC parameter is information indicating a path loss reference signal. Another example of OLPC parameter is information indicating a desired received power associated with the OLPC for the first TRP 130-1. In this way, by configuring these parameters, the power employed for the OLPC for the first TRP 130-1 may be calculated. As one example, the first configuration is comprised in the IE of PUCCH-SpatialRelationInfo, and the OLPC parameter may be PUCCH-PathlossReferenceRS-Id specifying the path loss reference signal and p0-PUCCH-Id specifying the desired received power.

Accordingly, the second configuration may comprise the similar types of parameters as the first configuration. For brevity, the same or similar contents are omitted here.

In some example embodiment, the value for each parameter in the first configuration may be the same with that in the second configuration. Alternatively, the value for each parameter in the first configuration may be different from that in the second configuration.

In addition to the transmission power parameters as discussed above, the first TRP 130-1 and the second TRP 130-2 may be configured with different beam.

Specifically, the first configuration may comprise a first beam identification. The first beam identification indicates the beam associated with the first TRP. Accordingly, the second configuration may comprise a second beam identification. The second beam identification indicates the beam associated with the second TRP. In this way, the PUCCH resource may be assigned to the specific TRP. As one example, the first configuration is comprised in the PUCCH-SpatialRelationInfo, the beam identification is servingCellId and referenceSignal.

It is to be understood that the parameters discussed above are only for the purpose of illustration without suggesting any limitations to the present disclosure, and the first and second configurations may comprise any suitable further parameters according to the specific application scenario.

After receiving the first message, the UE 110 may determine the configuration information associated with the configured PUCCH resources. Then the UE 110 performs 220 the PUCCH transmission with the BS 120 via the first TRP 130-1 and the second TRP 130-2 based on the received first message.

In this way, the separate transmission configuration corresponding to the first TRP 130-1 and the second TRP 130-2 can be achieved and the reliability of PUCCH transmission is enhanced.

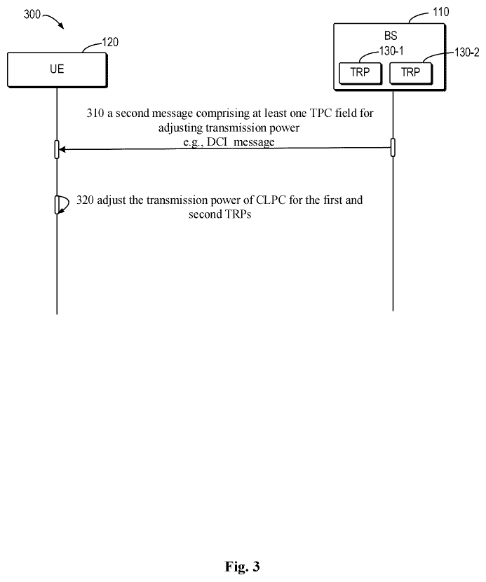

FIG. 3 illustrates a signaling flow 300 for adjusting the transmission power according to some embodiments of the present disclosure. For the purpose of discussion, the signaling flow 300 will be described with reference to FIG. 1. The signaling flow 300 may involve the BS 110, the UE 120, the first TRP 130-1 and the second TRP 130-2.

In the specific example of FIG. 3, in the signaling flow 300, the BS 110 associated with a first TRP 130-1 and a second TRP 130-2 transmits 310 a second message comprising at least one Transmission Power Control (TPC) field for adjusting transmission power for the first TRP 130-1 and second TRP 130-2. Upon receiving the second message, the UE 120 adjusts 320 the transmission power of CLPC for the first TRP 130-1 and the second TRP 130-2 based on the second message.

In this way, separate transmission power adjustments of CLPC for the first TRP 130-1 and the second TRP 130-2 can be achieved and the reliability of the PUCCH transmission is enhanced.

In some example embodiments, the BS 110 may adjust the transmission power by means of TPC field comprised in a Downlink Control Information (DCI) message.

The value in the TPC field indicates an adjustment of the transmission power control. One example mapping of TPC field in DCI format 0_0, DCI format 0_1 is illustrated as below Table 1.

TABLE 1
TPC Field Value Mapping Table

| Value of the TPC Field | Accumulated [dB] | Absolute [dB] |
|---|---|---|
| 1 | −1 | −4 |
| 2 | 0 | −1 |
| 3 | 1 | 1 |
| 4 | 3 | 4 |

The bit size of TPC field is typically 2 and there are four values for step size to adjust the transmission power control mapping with each of TPC field value which can be seen from Table 1.

In some example embodiments, the second message may comprise a single TPC field. Further, using a single TPC field to adjusting transmission power is conditionally allowed.

Specifically, if the first and second TRP are configured with a same index, the second message may comprise a single TPC field. Alternatively, if the first and second TRP are configured differently, the second message may comprise a single TPC field or two TPC fields.

In some example embodiments, if the CLPC for both of the TRPs are configured with a same index indicating that the CLPC is corresponding to the single TPC field, the CLPC for both of the TRPs may be configured with the single TPC field. Alternatively, in other example embodiments, the CLPC for both of the TRPs may be configured with the single TPC field regardless whether the indices configured for both of the TRPs indicates that the CLPC is corresponding to the single TPC or not. In this way, a large flexibility for adjusting the transmission power is achieved. In the following context, it is discussed regardless whether the CLPC for both of the TRPs is corresponding to the TPC field.

In some example embodiments, if the second message comprises a single TPC field, UE 120 may adjust the transmission power of CLPC for both of the first TRP 130-1 and the second TRP 130-2 based on the single TPC field, i.e. the power adjustment step size corresponding to the first TRP 130-1 and the second TRP 130-2 are the same.

Alternatively, in other example embodiments, if the second message comprises a single TPC field, the single TPC field may be viewed as two portions, namely a first portion and a second portion. In this case, UE 120 may adjust the transmission power of CLPC for the first TRP 130-1 according to a first portion of the single TPC field, and may adjust the transmission power of CLPC the second TRP 130-2 according to a second portion of the single TPC field.

In some example embodiments, if a bit size of the single TPC field is two, the first bit of the TPC field may be the first portion and the second bit may be the second portion. In this case, UE 120 may adjust the transmission power of CLPC for the first TRP 130-1 according to the first bit of the single TPC field, and adjust the transmission power of CLPC the second TRP 130-2 according to the second bit of the single TPC field. In this case, a new TPC value mapping table may be introduced.

Alternatively, if a bit size of the single TPC field is four, the first two bits of the TPC field may be viewed as the first portion of the TPC field and the second two bits of the TPC field may be viewed as the second portion of the TPC field. In this case, UE 120 may adjust the transmission power of CLPC for the first TRP 130-1 according to the first two bits of the single TPC field, and adjust the transmission power of CLPC the second TRP 130-2 according to the second two bits of the single TPC field. In this way, the conventionally TPC value mapping table can be reused.

In addition to the single TPC configuration, in some example embodiments, the second message may comprise two TPC fields, namely a first TPC field and a second TPC field. In this event, the UE 120 may adjust the transmission power of CLPC for the first TRP 130-1 according to the first TPC field, and adjust the transmission power of CLPC the second TRP 130-2 according to the second TPC field. In this way, the transmission power control can be simply achieved without complex configurations.

In some example embodiments, the second message may further comprise an indication indicating whether a single TRP transmission or a multiple TRPs transmission is scheduled. In this case, if the single TRP transmission is scheduled by the second message, UE 120 may adjust the transmission power corresponding to a TRP being scheduled by the second message. Further, if the multiple TRPs transmission is scheduled by the second message, UE 120 may adjust the transmission power for both the first TRP 130-1 and the second TRP 130-2. In this way, further flexibility for PUCCH transmission is provided.

In some example embodiments, if the second message comprises two TPC fields and a single TRP transmission corresponding to a first TRP 130-1 is scheduled, UE 120 may adjust the transmission power of CLPC for the first TRP 130-1 according to a TPC field corresponding to the first TRP 130-1. In addition, if the second message comprises a single TPC field of a bit size of 4 and a single TRP transmission corresponding to a first TRP 130-1 is scheduled, UE 120 may adjust the transmission power of CLPC for the first TRP 130-1 according to the first or the second two bits of the TPC field corresponding to the first TRP 130-1.

Alternatively, if the second message comprises two TPC fields and a single transmission with a first TRP 130-1 is scheduled, UE 120 may adjust the transmission power of CLPC for the first TRP 130-1 according to both of the two TPC field. In addition, if the second message comprises a single TPC field of a bit size of 4 and a single TRP transmission corresponding to a first TRP 130-1 is scheduled, UE 120 may adjust the transmission power of CLPC for the first TRP 130-1 according to the first and the second two bits of the TPC field simultaneously. In this way, the dynamic power adjustment range is enlarged by applying two adjustment step sizes at one transmission.

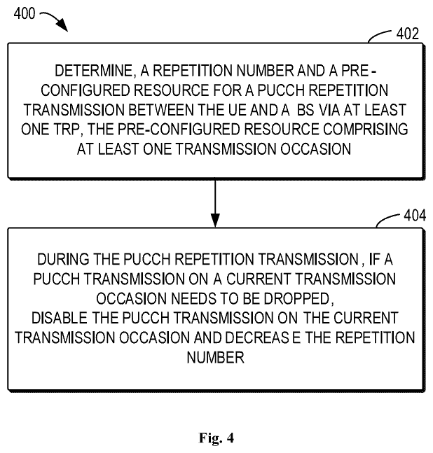

FIG. 4 illustrates a flowchart illustrating an example method 400 of determining PUCCH repetition pattern for a multiple TRP transmission performed by the UE according to some embodiments of the present disclosure. For example, the method 400 can be implemented at the UE 120 as shown in FIG. 1. It is to be understood that the method 400 may include additional blocks not shown and/or may omit some shown blocks, and the scope of the present disclosure is not limited in this regard.

As illustrated in FIG. 4, at block 402, the UE 120 determines, a repetition number and a pre-configured resource for a PUCCH repetition transmission between the UE 120 and the BS 110, where the pre-configured resource comprising at least one transmission occasion.

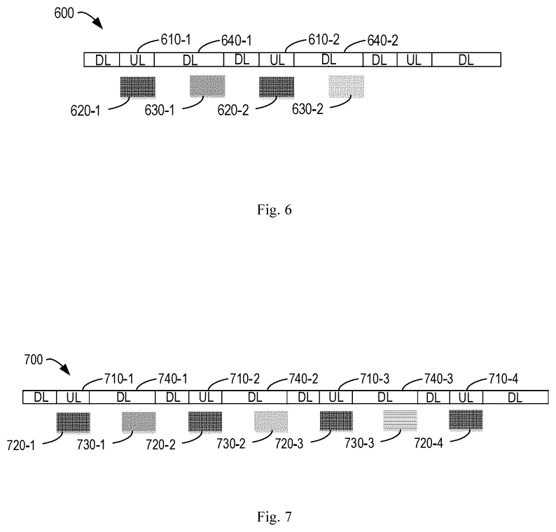

At block 404, during the PUCCH repetition transmission, if a PUCCH transmission on current transmission needs to be dropped (for example due to collision with a DL transmission from the BS 110), the UE 120 disables the PUCCH transmission on current transmission occasion and decreases the repetition number. The PUCCH repetition pattern associated with method 400 is illustrated in FIG. 6.

FIG. 6 illustrates a schematic block diagram of a PUCCH repetition pattern 600 corresponding to according to some embodiments illustrated in FIG. 4. As illustrated in FIG. 6, four PUCCH repetitions are to be transmitted. The PUCCH repetition 620-1 and PUCCH repetition 620-2 are transmitted at a UL transmission resource 610-1 (such as, a slot) and a UL transmission slot 610-2 respectively. However, one PUCCH repetition collides with DL transmissions 630-1 at DL transmission resource 640-1. Then UE 120 disables this PUCCH repetition and decreases the repetition number to 3. Again, another PUCCH repetition collides with DL transmissions 630-2 at DL transmission resource 640-2. Then UE 120 disables this PUCCH repetition and decreases the repetition number to 2. Since two PUCCH repetitions have already been transmitted, the PUCCH repetition transmission ends. The UE 120 disables two PUCCH repetitions while decreases the repetition number to 2.

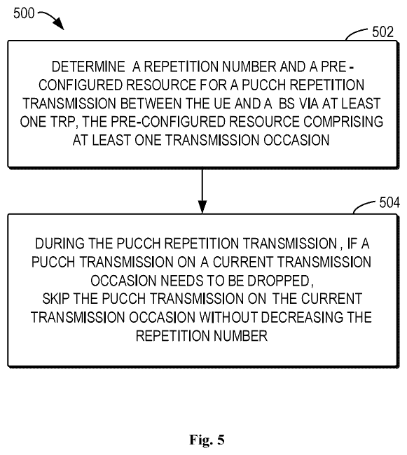

FIG. 5 illustrates a flowchart illustrating an example method 500 of determining PUCCH repetition pattern for a multiple TRP transmission performed by the UE according to some other embodiments of the present disclosure.

As illustrated in FIG. 5, at block 502, UE 120 determines, a repetition number and a pre-configured resource for a PUCCH repetition transmission between the UE and a BS via at least one TRP, the pre-configured resource comprising at least one transmission occasion.

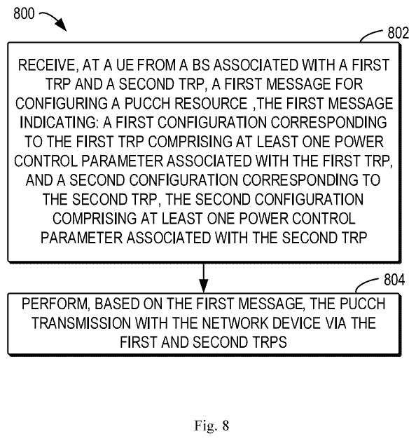

At block 504, during the PUCCH repetition transmission, if a PUCCH transmission on current transmission occasion needs to be dropped (for example due to collision with a downlink transmission from the BS 110), the UE 120 skips the PUCCH transmission on the current transmission occasion without decreasing the repetition number. The PUCCH repetition pattern associated with method 500 is illustrated in FIG. 7.

FIG. 7 illustrates a schematic block diagram of a PUCCH repetition pattern 700 corresponding to according to some embodiments illustrated in FIG. 5. As illustrated in FIG. 7, four PUCCH repetitions are to be transmitted. The PUCCH repetition 720-1 and PUCCH repetition 720-2 are transmitted at UL transmission resource 710-1 (such as, a slot) and a UL transmission slot 710-2 respectively. However, the other two PUCCH repetitions collide with DL transmissions 730-1 and 730-2 at DL transmission slots 740-1 and 740-2 respectively. In this case, the UE 120 skip the PUCCH transmission at DL transmission resources 740-1 and 740-2 without decreasing the repetition number and transmits the PUCCH repetition 720-3 at UL transmission slot 710-3 and transmits PUCCH repetition 720-4 and a UL transmission resource 710-4 after a DL transmission 730-3 is transmitted at the DL transmission resource 740-3.

In this way, two different PUCCH repetition pattern for multiple TRP transmission can be achieved. Collison of PUCCH repetition with a DL transmission may be well handled.

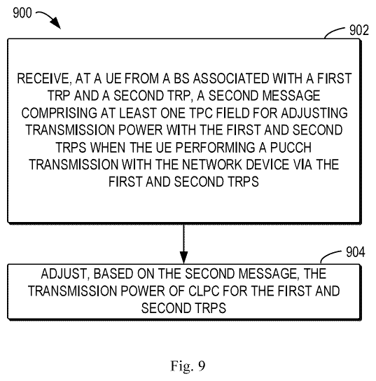

FIG. 8 illustrates a flowchart illustrating an example method 800 of configuring a PUCCH resource for a multiple TRP transmission performed by the UE 120 according to some embodiments of the present disclosure. The method 800 can be implemented at a device, for example the UE 120 shown in FIG. 1. It is to be understood that the method 800 may include additional blocks not shown and/or may omit some shown blocks, and the scope of the present disclosure is not limited in this regard.

At block 810, the UE 120 receive, at a UE 120 from a BS 110 associated with a first TRP 130-1 and a second TRP 130-2, a first message for configuring a PUCCH resource, the first message indicating: a first configuration corresponding to the first TRP 130-1 comprising at least one power control parameter associated with the first TRP 130-1, and a second configuration corresponding to the second TRP 130-2, the second configuration comprising at least one power control parameter associated with the second TRP 130-2.

At block 820, the UE 120 performs, based on the first message, the PUCCH transmission with the BS 110 via the first and second TRPs 130-1 and 130-2.

In some embodiments, the first message further may comprise an indication indicating the presence of the second configuration.

In some embodiments, the first configuration may comprise at least one of: at least one first CLPC parameter, and at least one first OLPC parameter.

In some embodiments, the second configuration may comprise at least one of: at least one second CLPC parameter being the same or different with the at least one first CLPC parameter, and at least one second OLPC parameter being the same or different with the at least one first OLPC parameter.

In some embodiments, the first message may comprise at least one Information Element (IE), the first configuration and the second configuration are comprised in the at least one IE.

In some embodiments, the IE may be PUCCH spatial relation information (PUCCH-spatial-relation-info).

In some embodiments, the at least one IE may comprise a first IE and a second IE correspond to the first and second TRPs, respectively. In this case, the first configuration may be comprised in the first IE and the second configuration is comprised in the second IE.

In some embodiments, in case of frequency range 2 (FR2), the first configuration further may comprise a first beam identification for the first TRP and the second configuration further comprises a second beam identification for the second TRP.

In some embodiments, the at least one first CLPC parameter may comprise a first CLPC index and the at least one second CLPC parameter comprises a second CLPC index.

In some embodiments, the first message may be a Radio Resource Control (RRC) message or a Media Access Control Control Element (MAC CE).

FIG. 9 illustrates a flowchart illustrating an example method 900 of adjusting the transmission power for CLPC for a multiple TRP transmission performed by the UE according to some embodiments of the present disclosure. The method 900 can be implemented at a device, for example the UE 120 shown in FIG. 1. It is to be understood that the method 900 may include additional blocks not shown and/or may omit some shown blocks, and the scope of the present disclosure is not limited in this regard.

At block 910, the UE 120 receives, from a BS 110 associated with a first TRP 130-1 and a second TRP 130-2, a second message comprising at least one TPC field for adjusting transmission power for the first and second TRPs 130-1 and 130-2 when the UE 120 performing a PUCCH transmission with the BS 110 via the first and second TRPs 130-1 and 130-2.

At block 920, the UE 120 adjusts, based on the second message, the transmission power of CLPC for the first and second TRPs 130-1 and 130-2.

In some embodiments, if the second message comprises a single TPC field, the UE 120 may adjust, based on the single TPC field, the transmission power of CLPC for both of the first and second TRPs 130-1 and 130-2.

In some embodiments, if the second message comprises a single TPC field, the UE 120 may adjust, according to a first portion of the single TPC field, the transmission power of CLPC for the first TRP 130-1. The UE 120 may further adjust, according to a second portion of the single TPC field, the transmission power of CLPC the second TRP 130-2.

In some embodiments, if a bit size of the single TPC field is two, the UE 120 may adjust, according to the first bit of the single TPC field, the transmission power of CLPC for the first TRP 130-1. The UE 120 may further adjust, according to the second bit of the single TPC field, the transmission power of CLPC the second TRP 130-2.

In some embodiments, if a bit size of the single TPC field is four, the UE 120 may adjust, according to the first two bits of the single TPC field, the transmission power of CLPC for the first TRP 130-1. The UE 120 may further adjust, according to the second two bits of the single TPC field, the transmission power of CLPC the second TRP 130-2.

In some embodiments, the second message may further comprise an indication indicating whether a single TRP transmission or a multiple TRPs transmission is scheduled. In this case, if the single TRP transmission is scheduled by the second message, the UE 120 may adjust the transmission power corresponding to a TRP being scheduled by the second message and if the multiple TRPs transmission is scheduled by the second message, the UE 120 may adjust the transmission power for both the first and second TRPs 130-1 and 130-2.

In some embodiments, if the second message comprises a first TPC field and a second TPC field, the UE 120 may adjust, according to the first TPC field, the transmission power of CLPC for the first TRP 130-1 and adjust, according to the second TPC field, the transmission power of CLPC the second TRP 130-2.

In some embodiments, if the second message comprises two TPC fields and a single TRP transmission with a first TRP 130-1 is scheduled, the UE 120 may adjust, according to a TPC field corresponding to the first TRP, the transmission power of CLPC for the first TRP 130-1.

In some embodiments, the second message comprises two TPC fields and a single TRP transmission with a first TRP 130-1 is scheduled, the UE 120 may adjust, according to both of the two TPC field, the transmission power of CLPC for the first TRP 130-1.

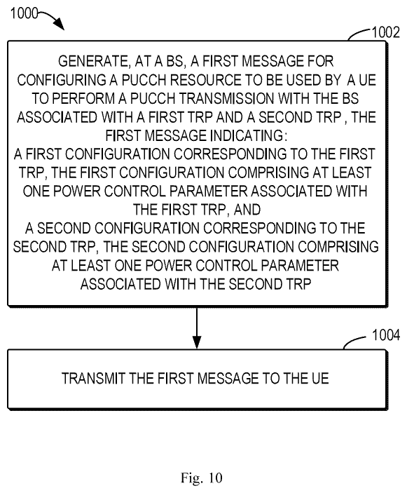

FIG. 10 illustrates a flowchart illustrating an example method of configuring a PUCCH resource for a multiple TRP transmission performed by the BS according to some embodiments of the present disclosure. The method 1000 can be implemented at a device, for example the BS 110 shown in FIG. 1. It is to be understood that the method 1000 may include additional blocks not shown and/or may omit some shown blocks, and the scope of the present disclosure is not limited in this regard.

At block 1010, the BS 110 generates a first message for configuring a Physical Uplink Control Channel (PUCCH) resource to be used by the UE 120 to perform a PUCCH transmission with the BS associated with a first TRP 130-1 and a second TRP 130-2. In this case, the first message indicate: a first configuration corresponding to the first TRP 130-1, the first configuration comprising at least one power control parameter associated with the first TRP 130-1, and a second configuration corresponding to the second TRP 130-2, the second configuration comprising at least one power control parameter associated with the second TRP 130-2.

At block 1020, the BS 110 transmits the first message to the UE 120.

In some embodiments, the first message may further comprise an indication indicating the presence of the second configuration.

In some embodiments, the first configuration may comprise at least one of: at least one CLPC parameter, and at least one first OLPC parameter.

In some embodiments, the second configuration may comprise at least one of: at least one second CLPC parameter being the same or different with the at least one first CLPC parameter, and at least one second OLPC parameter being the same or different with the at least one first OLPC parameter.

In some embodiments, the first message may comprise at least one Information Element (IE), the first configuration and the second configuration are comprised in the at least one IE.

In some embodiments, the IE may be PUCCH spatial relation information (PUCCH-spatial-relation-info).

In some embodiments, the at least one IE may comprise a first IE and a second IE correspond to the first and second TRPs, respectively. In this case, the first configuration is comprised in the first IE and the second configuration is comprised in the second IE.

In some embodiments, in case of frequency range 2 (FR2), the first configuration may further comprise a first beam identification for the first TRP and the second configuration further comprises a second beam identification for the second TRP.

In some embodiments, the at least one first CLPC parameter may comprise a first CLPC index and the at least one second CLPC parameter may comprise a second CLPC index.

In some embodiments, the first message may be a RRC message or a MAC CE message.

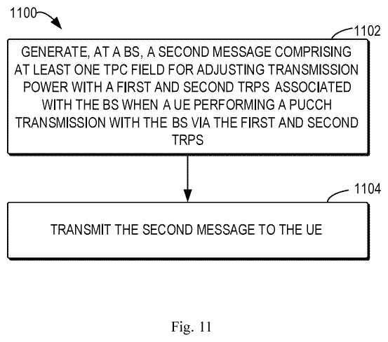

FIG. 11 illustrates a flowchart illustrating an example method 1100 of adjusting the transmission power for CLPC for a multiple TRP transmission performed by the BS 110 according to some embodiments of the present disclosure. The method 1100 can be implemented at a device, for example the BS 110 shown in FIG. 1. It is to be understood that the method 1200 may include additional blocks not shown and/or may omit some shown blocks, and the scope of the present disclosure is not limited in this regard.

At block 1110, the BS 110 generates a second message comprising at least one TPC field for adjusting transmission power for a first and second TRPs 130-1 and 130-2 associated with the BS 110 when the UE 120 performing a PUCCH transmission with the BS 110 via the first and second TRPs 130-1 and 130-2.

At block 1120, the BS 110 transmits the second message to the UE 120.

In some embodiments, if the transmission power of CLPC for both of the first and second TRPs 130-1 and 130-2 are to be adjusted identically, the second message comprises a single TPC field.

In some embodiments, the second message may comprise a single TPC field comprising a first portion for the transmission power of CLPC for the first TRP 130-1 and a second portion for the transmission power of CLPC the second TRP 130-2.

In some embodiments, if a bit size of the single TPC field is two, the first bit of the single TPC field may be for the transmission power of CLPC for the first TRP 130-1, and the second bit of the single TPC field may be for the transmission power of CLPC the second TRP 130-2.

In some embodiments, if a bit size of the single TPC field is four, the first two bits of the single TPC field may be for the transmission power of CLPC for the first TRP 130-1, and the second two bits of the single TPC field may be for the transmission power of CLPC the second TRP 130-2.

In some embodiments, the second message may further comprise an indication indicating whether a single TRP transmission or a multiple TRPs transmission is scheduled.

In some embodiments, the second message comprises a first TPC field and a second TPC field.

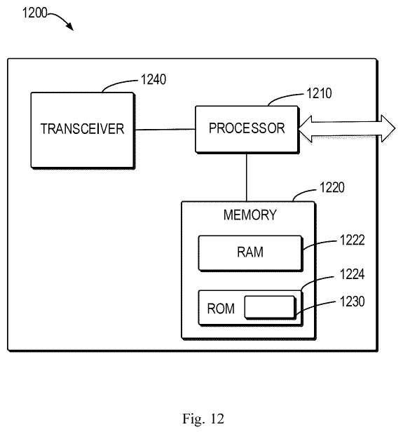

FIG. 12 illustrates a simplified block diagram of a device 1200 that is suitable for implementing embodiments of the present disclosure. For example, the BS 110 and the UE 120 can be implemented by the device 1200. As shown, the device 1200 includes a processor 1210, a memory 1220 coupled to the processor 1210, and a transceiver 1240 coupled to the processor 1210.

The transceiver 1240 is for bidirectional communications. The transceiver 1240 is coupled to at least one antenna to facilitate communication. The transceiver 1240 can comprise a transmitter circuitry (e.g., associated with one or more transmit chains) and/or a receiver circuitry (e.g., associated with one or more receive chains). The transmitter circuitry and receiver circuitry can employ common circuit elements, distinct circuit elements, or a combination thereof.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The program 1230 may be stored in the ROM 1224. The processor 1210 may perform any suitable actions and processing by loading the program 1230 into the RAM 1222.

The embodiments of the present disclosure may be implemented by means of the program 1230 so that the device 1200 may perform any process of the disclosure as discussed with reference to FIGS. 4-5, and 8-11. The embodiments of the present disclosure may also be implemented by hardware or by a combination of software and hardware.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4 and/or the method 500 as described above with reference to FIG. 5 and/or the method 800 as described above with reference to FIG. 8 and/or the method 900 as described above with reference to FIG. 9 and/or the method 1000 as described above with reference to FIG. 10 and/or the method 1100 as described above with reference to FIG. 11.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A processor of a user equipment (UE) configured to perform operations comprising:
receiving, from a base station (BS) associated with a first transmission and reception point (TRP) and a second TRP, a first message for configuring a Physical Uplink Control Channel (PUCCH) resource to be used by the UE to perform a PUCCH transmission with the BS, the first message indicating:
a first configuration corresponding to the first TRP, the first configuration comprising at least one power control parameter associated with the first TRP, and
a second configuration corresponding to the second TRP, the second configuration comprising at least one power control parameter associated with the second TRP; and
performing, based on the first message, the PUCCH transmission with the BS via the first and second TRPs.

2-9. (canceled)

10. The processor of claim 1, wherein the first message and the second message comprise a Radio Resource Control (RRC) message or a Media Access Control Control Element (MAC CE).

11. A processor of a user equipment (UE) configured to perform operations comprising:
receiving, from a base station (BS) associated with a first transmission and reception point (TRP) and a second TRP, a message comprising at least one transmission power control (TPC) field for adjusting transmission power for the first and second TRPs when the UE performing a PUCCH transmission with the BS via the first and second TRPs; and
adjusting, based on the message, the transmission power of Closed Loop Power Control (CLPC) for the first and second TRPs.

12. The processor of claim 11, wherein if the message comprises a single TPC field, the adjusting the transmission power of CLPC for the first and second TRPs comprises:
adjusting, based on the single TPC field, the transmission power of CLPC for both of the first and second TRPs.

13. The processor of claim 11, wherein if the message comprises a single TPC field, adjusting the transmission power of CLPC for the first and second TRPs comprises:
adjusting, according to a first portion of the single TPC field, the transmission power of CLPC for the first TRP; and
adjusting, according to a second portion of the single TPC field, the transmission power of CLPC the second TRP.

14. The processor of claim 13, wherein if a bit size of the single TPC field is two, adjusting the transmission power of CLPC for the first and second TRPs comprises:
adjusting, according to the first bit of the single TPC field, the transmission power of CLPC for the first TRP; and
adjusting, according to the second bit of the single TPC field, the transmission power of CLPC the second TRP.

15. The processor of claim 13, wherein if a bit size of the single TPC field is four, adjusting the transmission power of CLPC for the first and second TRPs comprises:
adjusting, according to the first two bits of the single TPC field, the transmission power of CLPC for the first TRP; and
adjusting, according to the second two bits of the single TPC field, the transmission power of CLPC the second TRP.

16. The processor of claim 11, wherein the message further comprises an indication indicating whether a single TRP transmission or a multiple TRPs transmission is scheduled, and
wherein the adjusting the transmission power of CLPC for the first and second TRPs based on the first message comprises:
if the single TRP transmission is scheduled by the message, adjusting the transmission power corresponding to a TRP being scheduled by the message; and
if the multiple TRPs transmission is scheduled by the message, adjusting the transmission power for both the first and second TRPs.

17. The processor of claim 11, wherein if the message comprises a first TPC field and a second TPC field, adjusting the transmission power of CLPC for the first and second TRPs based on the second comprises:
adjusting, according to the first TPC field, the transmission power of CLPC for the first TRP; and
adjusting, according to the second TPC field, the transmission power of CLPC the second TRP.

18. The processor of claim 16, wherein if the message comprises two TPC fields and a single TRP transmission with a first TRP is scheduled, adjusting the transmission power of CLPC for the first and second TRPs based on the message comprises:
adjusting, according to a TPC field corresponding to the first TRP, the transmission power of CLPC for the first TRP.

19. The processor of claim 16, wherein the message comprises two TPC fields and a single TRP transmission with a first TRP is scheduled, adjusting the transmission power of CLPC for the first and second TRPs based on the message comprises:
adjusting, according to both of the two TPC field, the transmission power of CLPC for the first TRP.

20-31. (canceled)

32. A processor of a base station (BS) configured to perform operations comprising:
generating a message comprising at least one transmission power control (TPC) field for adjusting transmission power for a first and second transmission and reception points (TRPs) associated with the BS when a User Equipment (UE) performing a PUCCH transmission with the BS via the first and second TRPs; and
transmitting the message to the UE.

33. The processor of claim 32, wherein if the first and the second TRP are configured with a same index, the message comprises a single TPC field.

34. The processor of claim 32, wherein the message comprises a single TPC field comprising a first portion for the transmission power of CLPC for the first TRP and a second portion for the transmission power of CLPC the second TRP.

35. The processor of claim 34, wherein a bit size of the single TPC field is two, the first bit of the single TPC field being for the transmission power of CLPC for the first TRP, and
the second bit of the single TPC field being for the transmission power of CLPC the second TRP.

36. The processor of claim 34, wherein a bit size of the single TPC field is four, the first two bits of the single TPC field being for the transmission power of CLPC for the first TRP, and
the second two bits of the single TPC field being for the transmission power of CLPC the second TRP.

37. The processor of claim 32, wherein the message further comprises an indication indicating whether a single TRP transmission or a multiple TRPs transmission is scheduled.

38. The processor of claim 32, wherein the message comprises a first TPC field and a second TPC field,
wherein the message comprises a first TPC field corresponding to the first TRP and a second TPC field corresponding to the second TRP.

39. (canceled)

40. The processor of claim 11, wherein the first message is a Radio Resource Control (RRC) message or a Media Access Control Control Element (MAC CE).

41. The processor of claim 32, wherein the first message is a Radio Resource Control (RRC) message or a Media Access Control Control Element (MAC CE).
